(19) United States
(12) Patent Application Publication
(10) Pub. No.: US 2022/0374501 A1
(43) Pub. Date: Nov. 24, 2022

(54) MODULE FOR PROCESSING DATA IDENTIFYING A FRACTILE OF A SET OF DATA

(71) Applicant: SAFRAN ELECTRONICS & DEFENSE, PARIS (FR)

(72) Inventor: François LEROY, MOISSY-CRAMAYEL (FR)

(73) Assignee: SAFRAN ELECTRONICS & DEFENSE, PARIS (FR)

(21) Appl. No.: 17/767,273

(22) PCT Filed: Oct. 8, 2020
(86) PCT No.: PCT/FR2020/051781

§ 371 Date: Apr. 7, 2022

(30) Foreign Application Priority Data
Oct. 8, 2019 (FR) FR1911121

(51) Int. Cl. G06F 17/18; G06F 7/501

(52) U.S. Cl. CPC G06F 17/18; G06F 7/501

(57) ABSTRACT

A module for processing a set of n input data comprising a reference datum, which is configured to a) calculate the sum of weights that are associated only with those input data other than the reference datum which have values strictly lower than the value of the reference datum; b) compare the sum calculated in step a) with a first threshold; c) calculate the sum of the weights that are associated only with those input data other than the reference datum which have values strictly higher than the value of the reference datum; d) compare the sum calculated in step c) with a second threshold; e) generate an output datum indicating whether the reference datum is a fractile of the set included in a predetermined subset of fractiles, only if: the sum calculated in step a) is lower than the first threshold and the sum calculated in step c) is lower than the second threshold.

### FIELD OF THE INVENTION

This invention relates to the field of methods and devices for identifying, in a set of data, a fractile belonging to a predetermined subset of fractiles, such as a median.

### PRIOR ART

There is known from document US 2012/076432 a filtering device of a set of n input data such as to produce an output value. The output value is the median of the respective values of the n input data. The median is a specific fractile which divides the set of n data (once it is ordered) into two groups of equal sizes.

This device comprises several processing units, including a determining unit implementing minima search to determine the median.

A drawback of this device is that the minima search implemented is a relatively complex operation. This has two consequences: this search extends the processing time of the device, and cannot be implemented in components of extremely small surface area.

### SUMMARY OF THE INVENTION

One aim of the invention is to determine a fractile of a set of data more quickly and/or in a way that can be implemented over an extremely small surface area.

For this effect provision is made, according to a first aspect, for a module for processing a set of n input data comprising a reference datum, each input datum having a value, each input datum being moreover associated with a weight, the processing module being configured to:

a) compute the sum of the weights associated solely with input data other than the reference datum which have values strictly less than the value of the reference datum,

b) compare the sum computed in step a) with a first threshold,

c) compute the sum of the weights associated solely with input data other than the reference datum which have values strictly greater than the value of the reference datum,

d) compare the sum computed in step c) with a second threshold,

e) generate an output datum indicating whether or not the reference datum is a fractile of the set included in a predetermined subset of fractiles, only if both the following conditions are satisfied: the sum computed in step a) is less, strictly or not, than the first threshold and the sum computed in step c) is less, strictly or not, than the second threshold.

The module according to the first aspect may comprise the following features, taken alone or combined with one another when this is technically possible.

Preferably, the output datum is a Boolean.

Preferably, the processing module comprises:
a plurality of first comparators arranged in parallel, each first comparator being configured to generate a result of a comparison between the value of the reference datum and the value of another input datum of the set,
a first adder configured to implement step a) on the basis of the results generated by the first comparators.

Preferably, the processing module comprises:
a plurality of second comparators arranged in parallel, each second comparator being configured to generate a result of a comparison between the value of the reference datum and the value of another input datum of the set,
a second adder configured to implement step c) on the basis of the results generated by the second comparators.

Preferably, the processing module comprises: two comparators configured to respectively generate two results of a comparison between the value of the reference datum and the value of another input datum of the set, wherein one of the two comparators is configured to be limited to testing an equality between the value of the reference datum and the value of the other input datum of the set, and the other of the two comparators is configured to be limited to testing an order relationship between the value of the reference datum and the value of the other input datum of the set, the processing module being moreover configured to cross the two results to determine if the weight of the other value is to be included in the sum computed in step a) or in the sum computed in step c).

Preferably, the sum of the first threshold and the second threshold is equal to s+p, where s is the sum of the weights of the n input data, and where p∈[−1, 1], p being a function of knowing whether or not the sum computed in step a) must be strictly less than the first threshold and whether or not the sum computed in step b) must be strictly less than the second threshold for the two conditions to be satisfied.

Preferably, the predetermined set of fractiles is composed of a single fractile.

Preferably, the predetermined set of fractiles comprises the median of the set of n input data.

Preferably, the n weights are all equal to 1.

Preferably, the set of n input data is a neighborhood of pixels in an image.

Preferably, step a) comprises:

a1) initializing a first counter to a sum that has been computed during a preceding implementation of step a) by the processing module to process a preceding set of data comprising the same reference datum, the set of n input data moreover comprising at least one new datum which was not present in the preceding set of data, and the preceding set of data comprises at least one old datum which is not present in the set of n input data,

a2) for each new datum, incrementing the first counter with the weight associated with the new datum, only if a predetermined relationship between the value of the new datum and the value of the reference datum is verified,

a3) for each old datum, decrementing the first counter with the weight associated with the old datum, only if a predetermined relationship between the value of the old datum and the value of the reference datum is verified.

Preferably the step c) comprises:

c1) initializing a second counter to a sum that has been computed during a preceding implementation of step c) by the processing module to process a preceding set of data comprising the same reference datum, the set of n input data moreover comprising at least one new datum which was not present in the preceding set of data, and the preceding set of data comprises at least one old datum which is not present in the set of n input data,

c2) for each new datum, incrementing the second counter with the weight associated with the new datum, only if a predetermined relationship between the value of the new datum and the value of the reference datum is verified,

c3) for each old datum, decrementing the second counter with the weight associated with the old datum, only if a predetermined relationship between the value of the old datum and the value of the reference datum is verified.

Preferably, the predetermined relationships are relationships of strict order.

Preferably, the set of n input data and the preceding set of data are neighborhoods of pixels in an image which overlap.

Preferably, the processing module is moreover configured to:
b′) compare the sum computed in step a) with a third threshold,
d′) compare the sum computed in step c) with a fourth threshold,
e′) generate an output datum indicating whether or not the reference datum is a fractile of the set included in a second predetermined subset of fractiles different from the subset of step e), only if the two following conditions are satisfied: the sum computed in step a) is less, strictly or not, than the third threshold and the sum computed in step c) is less, strictly or not, than the fourth threshold.

Provision is also made, according to a second aspect, for a device for filtering a set of n data such as to produce a fractile of the set included in a predetermined subset of fractiles, each input datum having a value, each input datum being moreover associated with a weight, the filtering device comprising:
a plurality of processing modules according to the first aspect, arranged in parallel, each processing module being itself associated with one of the n input data and configured to process as reference datum the input datum of the set with which it is itself associated,
a module for generating fractiles configured to generate the fractile on the basis of the output data respectively generated by the processing modules.

The filtering device according to the second aspect may comprise the following features, taken alone or combined with one another when this is technically possible.

Preferably, the fractile-generating module is configured to:

f) for each output datum generated by a processing module, apply an operation of bitwise type and logic between the output datum generated by this processing module and the value of the input datum associated with the processing module itself, such as to produce results,

g) apply an operation of bitwise type or logic to the results of step f).

Preferably, the filtering device comprises a comparator configured to generate a result of a comparison between the value of a first datum of the set and the value of a second datum of the set, and wherein the plurality of processing modules comprises:
a first processing module configured to process as reference datum a first datum of the set, the first processing module being configured to implement one from among steps a) and c) on the basis of the result generated by the comparator,
a second processing module configured to process as reference datum a second datum of the set, the second processing module being configured to implement one from among steps a) and c) on the basis of the result generated by the comparator.

Preferably, the set of n input data comprises two input data in common with a preceding set of data previously processed by the filtering device, and one of the processing modules is configured to implement step a) or step c) on the basis of a result of a comparison between the two common input data that has been previously generated by the processing module to process the preceding set of data

Preferably, step a) implemented by a processing module comprises:

a1) initializing a first counter to a sum that has been computed during a preceding implementation of step a) to filter a preceding set of data, the set of n input data comprising at least one new datum which was not present in the preceding set of data, and comprising an input datum in common with the preceding set of data, the preceding set of data comprising at least one old datum which is not present in the set of n input data,

a2) for each new datum, incrementing the first counter with the weight associated with the new datum, only if a predetermined relationship between the value of the new datum and the value of the common input datum is verified,

a3) for each old datum, decrementing the first counter with the weight associated with the old datum, only if a predetermined relationship between the value of the old datum and the value of the common input datum is verified.

Preferably, the step c) implemented by a processing module comprises:

c1) initializing a first counter to a sum that has been computed during a preceding implementation of step c) to filter a preceding set of data, the set of n input data moreover comprising at least one new datum which was not present in the preceding set of data, and comprising an input datum in common with the preceding set of data, the preceding set of data comprising at least one old datum which is not present in the set of n input data,

c2) for each new datum, incrementing the first counter with the weight associated with the new datum, only if a predetermined relationship between the value of the new datum and the value of the common input datum is verified,

c3) for each old datum, decrementing the first counter with the weight associated with the old datum, only if a predetermined relationship between the value of the old datum and the value of the common input datum is verified.

Preferably, the predetermined relationships are relationships of a strict order.

Preferably, the number of processing modules arranged in parallel is strictly less than n, such that at least one of the n input data, the so-called remaining datum, is not processed as a reference datum by any of the processing modules, the filtering device moreover comprising an additional module configured to generate an output datum indicating whether or not the remaining datum is a fractile of the set included in the predetermined sub-set of fractiles, on the basis of the output data generated by the processing modules.

Provision is also made, according to a third aspect, for a device for processing an input image to produce an output image, the processing device comprising:
a module for selecting pixels configured to select a neighborhood of n pixels in the input image,
a filtering device according to the second aspect, configured to filter the selected neighborhood of n pixels, such as to produce a fractile of the neighborhood of n pixels, the fractile constituting a value of a pixel of the output image.

Provision is also made, according to a fourth aspect, for a method for processing a set of n input data comprising a reference datum, each input datum having a value, each input datum being moreover associated with a weight, the method comprising the following steps implemented by a processing module:

a) computing the sum of the weights associated solely with input data other than the reference datum which have values strictly less than the value of the reference datum,

b) comparing the sum computed in step a) with a first threshold,

c) computing the sum of the weights associated solely with input data other than the reference datum which have values strictly greater than the value of the reference datum,

d) comparing the sum computed in step c) with a second threshold,

e) generating an output datum indicating whether or not the reference datum is a fractile of the set included in a predetermined subset of fractiles, only if the two following conditions are satisfied: the sum computed in step a) is less, strictly or not, than the first threshold and the sum computed in step c) is less, strictly or not, than the second threshold.

Provision is also made, according to a fifth aspect, for a method for filtering a set of n input data such as to produce a fractile of the set included in a predetermined subset of fractiles, each input datum having a value, each input datum being moreover associated with a weight, the method comprising:
implementing the processing method according to the fourth aspect several times in parallel, each implementation of said processing method processing a different input datum from the set as the reference datum,
generating the fractile on the basis of the output data generated during parallel implementations of the processing method.

Preferably, the set of n input data filtered by the method according to the fifth aspect is a neighborhood of pixels of an image.

Provision is also made, according to a sixth aspect, for a computer program product comprising program code instructions for executing the steps of the method according to the fifth aspect, when this program is executed by a computer.

### DESCRIPTION OF THE FIGURES

Other features, aims and advantages of the invention will become apparent from the following description, which is purely illustrative and non-limiting, and which must be read with reference to the appended drawings wherein:

FIG. 1 schematically illustrates a processing module according to a first embodiment of the invention.

FIG. 2 schematically illustrates a processing module according to a second embodiment of the invention.

FIG. 3 schematically illustrates a processing module according to a third embodiment of the invention.

FIG. 4 schematically illustrates a filtering device according to a first embodiment.

FIG. 5 schematically illustrates a filtering device according to a second embodiment.

FIG. 6 schematically illustrates an image-processing device according to a first embodiment.

FIG. 7 schematically illustrates a filtering device according to a third embodiment.

FIG. 8 schematically illustrates a filtering device according to a fourth embodiment.

FIG. 9 schematically illustrates a part of an image and two neighborhoods of pixels selected in this image.

FIG. 10 schematically illustrates a part of an image and three neighborhoods of pixels selected in this image.

In all the figures, similar elements bear identical reference numbers.

### DETAILED DESCRIPTION OF THE INVENTION

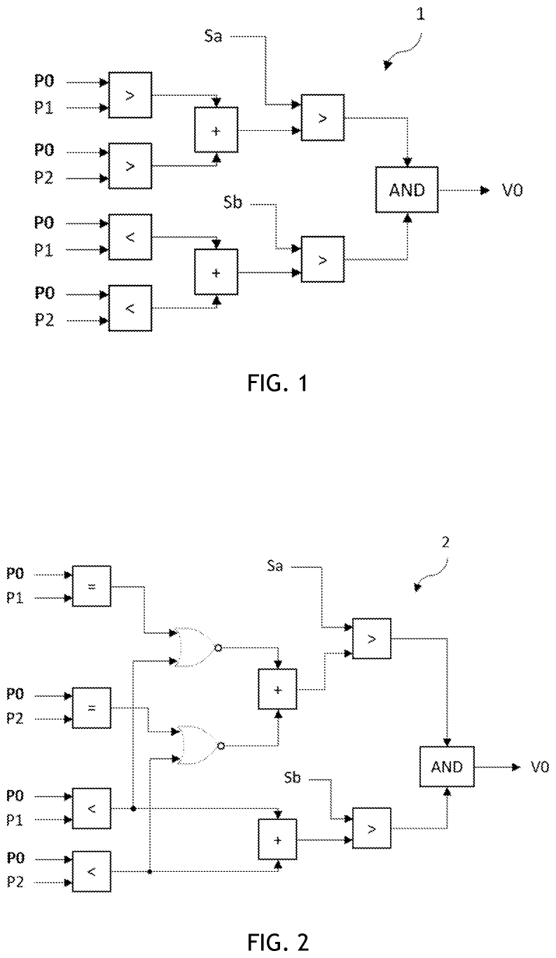

FIG. 1 shows a processing module 1 according to a first embodiment. The processing module 1 takes as input a set of n input data. Each input datum has a value.

The processing module 1 has the function of testing whether or not the value of one of the input data, referred to in the rest of the text as reference datum, is a predetermined fractile of the set of n input data.

The processing module 1 is configured to implement the following steps:

a) compute the number of input data other than the reference datum which have values strictly less than the value of the reference datum,

b) compare the number computed in step a) with a first threshold Sa,

c) compute the number of input data other than the reference datum which have values strictly greater than the value of the reference datum,

d) compare the sum computed in step c) with a second threshold Sb,

e) generate an output datum V0 indicating whether or not the reference datum is a predetermined fractile of the set of n data, only if the two following conditions are satisfied: the sum computed in step a) is strictly less than the first threshold Sa and the sum computed in step c) is strictly less than the second threshold Sb.

In the embodiment illustrated in FIG. 1, n=3. The respective values of the three input data are denoted P0, P1, P2. The value of the reference datum is P0.

There will now follow a detailed description of the structure of the processing module 1 allowing it to implement the preceding steps.

The processing module 1 comprises a plurality of primary comparators arranged in parallel. Each primary comparator comprises two inputs and an output. Each primary comparator is configured to compare two values that it receives via its two inputs, and provide on its output a result providing information on the comparison made.

Each primary comparator is limited to checking whether or not the two values that are passed to it as inputs verify a predetermined binary relationship R specific to the comparator. The result supplied as output is then an item of Boolean information. In other words each primary comparator is limited to verifying whether or not xRy is true, where x and y are the two values received via the two inputs.

The inputs of the primary comparators are shown in the figures one on top of the other; by convention, x (left operand of R) is the value received on the top input, and y (right operand of R) is the value received on the bottom input. The binary relationship tested by a comparator is indicated in the figures by the corresponding symbol.

Still by convention, a result supplied by a primary comparator is said to be “positive” if the binary relationship R that it examines is verified by values that it receives as input, and is said to be “negative” in the opposite case. For example, a positive result is represented by the value 1, while a negative result is represented by the value 0 (zero).

In the first embodiment illustrated in FIG. 1, the binary relationship R verified by each primary comparator is a relationship of strict order (R thus being able to be < or >).

The primary comparators are arranged to receive as input the value P0 of the input reference datum and the value of one of the other input data (here, P1 or P2 since n=3). In other words, these comparators are configured to generate a result of a comparison of the value P0 of the reference datum with the value of another input datum of the set.

The plurality of comparators thus comprises:
a first group of n−1 comparators supplying a result indicating whether or not the value P0 of the reference datum is strictly greater than the value of another input datum (in FIG. 2, these comparators bear the symbol >); and
a second group of n−1 comparators supplying a result indicating whether or not the value P0 of the reference datum is strictly less than the value of another input datum (in FIG. 2, these comparators bear the symbol <).

In the processing module 1 illustrated in FIG. 1 and for which N=3, the groups are constituted as follows:
the first group of comparators of type > comprises two comparators consisting of
   one comparator verifying whether or not P0>P1 and
   one comparator verifying whether or not P0>P2,
the second group of comparators of type < comprises two comparators consisting of
   one comparator verifying whether or not P0<P1 and
   one comparator verifying whether or not P0<P2.

The processing module 1 further comprises a first adder, and a second adder (denoted in FIG. 1 by the sign +).

The first adder is connected to the respective outputs of the comparators of the first group. The first adder is configured to determine the number of input data other than the input reference datum which are of value strictly less than the value P0 of the reference datum (step a). This determined number is the output of the first adder.

To do this, the first adder can quite simply initialize a first counter to zero, and increment this first counter by an increment equal to 1 each time the first adder receives a positive result from a comparator belonging to the first group.

Similarly, the second adder is connected to the respective outputs of the comparators of the second group. The second adder is configured to determine the number of input data other than the input reference datum which are of value strictly greater than the value P0 of the reference datum (step c). This determined number is the output of the second adder.

To do this, the second adder can simply initialize a second counter to zero and increment this second counter by an increment equal to 1 each time the second adder receives a positive result from a comparator belonging to the second group.

The processing module 1 further comprises a first secondary comparator and a second secondary comparator (illustrated to the right of the adders).

The two secondary comparators are comparators limited to verifying a relationship of strict order, just like the primary comparators.

More precisely, the first secondary comparator (top right of FIG. 1) is configured to verify whether or not the number determined by the first adder is strictly less than the first threshold Sa (step b) of the method). If so, the first comparator generates a positive result on its output, for example represented by the value 1; otherwise, the first comparator generates a negative result on its output, for example represented by the value 0.

Similarly, the second secondary comparator (bottom right of FIG. 1), is configured to verify whether or not the number determined by the second adder is strictly less than the second predetermined threshold Sb (step d) of the method). If so, the first comparator generates a positive result on its output, for example represented by the value 1; otherwise, the first comparator generates a negative result on its output, for example represented by the value 0.

To produce the output datum V0, the processing module 1 may comprise a logic gate of AND type taking as input the results supplied by the secondary comparators. In this case, when V0 has a value of 1, V0 indicates that the value of the reference datum is a predetermined fractile of the set of n input data.

The fractile tested by the processing module 1 depends on the values assigned to the two thresholds Sa, Sb.

If the first threshold and the second threshold each have a value of (n+1)/2, n being odd, then the fractile tested by the processing module 1 is a median; in other words, the processing module 1 then has the function of testing whether or not the value P0 is the median of the values of the n input data.

In an embodiment, one can set Sa=n and Sb=1. In this embodiment, the tested fractile is the maximum value from among the values of the n input data. In other words, the module has the function of determining whether or not the reference value is the input datum of the set of maximum value.

In another embodiment, it is possible to set Sa=1 and Sb=n. In this case, the tested fractile is the minimum value from among the values of the n input data. In other words, the module has the function of determining whether or not the reference value is the input datum of the set of minimum value.

The operation of the processing module 1 can be illustrated by two examples (it is supposed in these examples that Sa=Sb=(n+1)/2, therefore that the tested fractile is the median).

Let us suppose in a first example that P0>P1>P2. The processing module 1 then proceeds as follows:
The two comparators of the first group each supply a positive result to the first adder, so that the first counter reaches the value 2 after being incremented twice. The value of the first counter is transmitted to the first secondary comparator, which observes that this value is not strictly less than the first threshold (the value of the first counter is specifically equal to the first threshold having a value of (n+1)/2). The first secondary comparator therefore generates a negative result.
Moreover, the two comparators of the second group each supply a negative result to the second adder, so that the second counter remains at zero. The value of the second counter is transmitted to the first secondary comparator, which observes that this value is indeed strictly less than the second threshold (zero is strictly less than (n+1)/2). The second secondary comparator therefore generates a positive result.
As the two results generated by the second secondary comparators are not both positive, the processing module 1 comes to the conclusion that the value P0 is not a median.

Let us now suppose that P1<P0<P2. The processing module 1 proceeds as follows:
Only one of the comparators of the first group supplies a positive result to the first adder, so that the first counter reaches the value of 1 after being incremented once. The value of the first counter is transmitted to the first secondary comparator, which observes that this value is indeed strictly less than the first threshold (1<2). The first secondary comparator therefore generates a positive result.
Similarly, only one of the comparators of the second group supplies a positive result to the second adder, such that the second counter reaches the value of 1 after being incremented once. The value of the second counter is transmitted to the second secondary comparator, which observes that this value is indeed strictly less than the first threshold (1<2). The second secondary comparator therefore generates a positive result.
As the results generated by the two secondary comparators are both positive, the processing module 1 comes to the conclusion that the value P0 is indeed the median of the values P0, P1, P2.

Note that the processing module 1 functions correctly even in the case where several of the n input data have equal values, in particular several values equal to the tested fractile.

FIG. 2 illustrates a processing module 2 according to a second embodiment. This second embodiment differs from the first embodiment by the following features.

The primary comparators of the first group do not verify a relationship of strict order, but are limited to verifying a relationship of equality, which has the advantage of allowing a reduction of their surface. Thus, the result supplied by a primary comparator of the first group is positive if the two compared values are equal, and this result is negative in the opposite case (if the two compared values are different).

In the processing module 2 illustrated in FIG. 2 and for which n=3, the groups of primary comparators are constituted as follows:
the first group of primary comparators of type=comprises two comparators consisting of
   one comparator verifying whether or not P0=P1 and
   one comparator verifying whether or not P0=P2,
the second group of primary comparators of type < comprises two comparators consisting of
   one comparator verifying whether or not P0<P1 and
   one comparator verifying whether or not P0<P2.

Thus, in the processing module 2, there are two comparators which compare the value of the reference datum and the value of one and the same other input datum, but the comparisons implemented by these two comparators are based on different binary relationships, such that these two comparators supply results giving information of different kinds: one of these results indicates whether or not the value of the reference datum is equal to the other value, and the other indicates whether or not a relationship of strict order is verified by the reference datum and the value of the other input datum.

The processing module 2 is configured to cross these two results of different kinds, to determine whether or not the other datum must be taken into account by the first adder.

In practice, this crossing is implemented by means of an additional logic gate of NOT-OR (NOR) type taking as input the two results and the output of which is linked to the first adder.

To illustrate the reduction in surface area that can be obtained in the processing module 2, by comparison with the processing module 1, the example of values encoded on 16 bits will be considered. A comparator verifying a relationship of strict order (equivalent to a subtraction in terms of complexity) can then be implemented using 16 LUT6. A comparator limited to verifying an equality can meanwhile be implemented using 16/3 LUT6 (an equality is a bitwise comparison+a tree of these comparisons). The necessary cost to cross two results is 7 LUT, but remains low enough to make it possible to reduce the overall surface area of the processing module 2 with respect to the processing module 1.

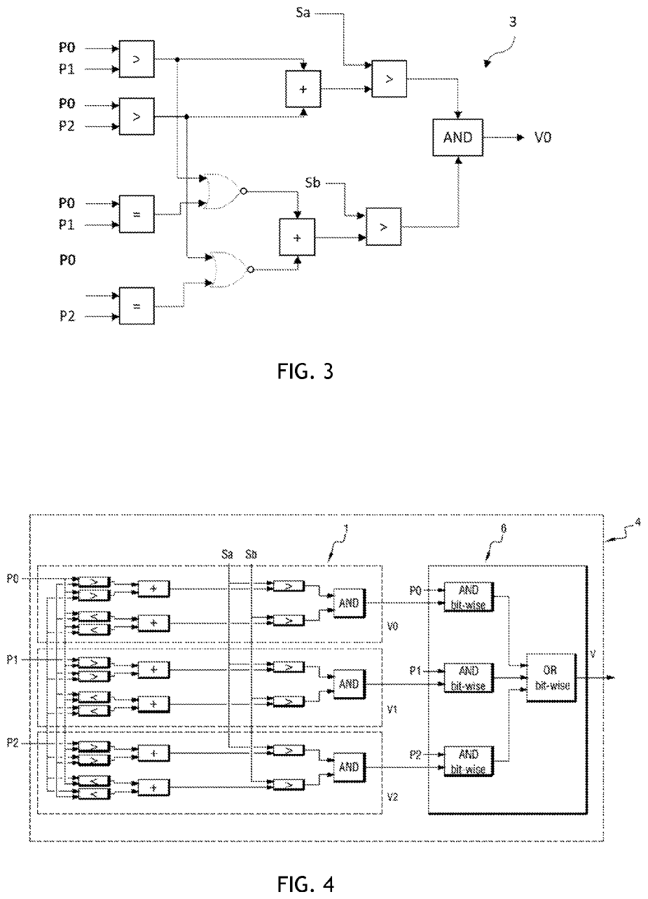

FIG. 3 illustrates a processing module 3 according to a third embodiment. This third embodiment differs from the first embodiment by the following features.

The primary comparators of the second group do not verify a relationship of strict order, but are limited to verifying an equality relationship, which offers the advantage of allowing a reduction of their surface area. Thus, the result supplied by a primary comparator of the second group is positive if the two compared values are equal, and this result is negative in the opposite case (if the two compared values are different).

In the processing module 3 illustrated in FIG. 3 and for which n=3, the groups of primary comparators are constituted as follows:
the first group of primary comparators of type > comprises two comparators of which
   one comparator verifying whether or not P0>P1 and
   one comparator verifying whether or not P0>P2,
the second group of primary comparators of type=comprises two comparators of which
   one comparator verifying whether or not P0=P1 and
   one comparator verifying whether or not P0=P2.

Just like in the second embodiment, there exists in the third embodiment two comparators that compare the value of the reference datum and the value of another input datum, but the comparisons implemented by these two comparators rest on different binary relationships, such that these two comparators supply results giving information of different kinds: one of these results indicates whether or not the value of the reference datum is equal to the other value, and the other indicates whether or not a relationship of strict order is verified by the value of the reference datum and the value of the other input datum.

The processing module according to the second embodiment is configured to cross these two results of different kinds, to determine whether or not the other datum must be accounted for by the second adder.

In practice, this crossing is implemented by means of an additional logic gate of NOT-OR (NOR) type taking as input the two results and the output of which is linked to the second adder.

This third embodiment has the advantages of reduction in surface area as the second embodiment.

With reference to FIG. 4, a filtering device 4 comprises a plurality of processing modules 1. Each of these modules 1 is in accordance with the first embodiment. It will of course be understood that each of these modules 1 could be replaced by a processing module 2 according to the second embodiment or a processing module 3 according to the third embodiment.

The filtering device 4 comprises n inputs, one for each input datum.

Each of the processing modules 1 of the filtering device 4 is itself associated with one of the input data. Each processing module 1 is configured to process as reference datum the input datum that is associated with it. The number of processing modules 1 of the filtering device 4 is thus at the most equal to n. The processing module processing the datum of value Pi as the reference datum, an output datum Vi which indicates whether or not Pi is the predetermined fractile. The processing modules 1 of the filtering device 4 are arranged in parallel, in the sense that they are configured to operate in parallel.

The filtering device 4 shown in FIG. 4, and for which n=3 thus comprises three processing modules 1, including:
a first processing module 1 processing the first datum of value P0 as reference datum, such as to produce the output datum V0 which indicates whether or not P0 is the sought fractile
a second processing module 1 processing the second datum of value P1 as reference datum, such as to produce an output datum V1 indicating whether or not P1 is the sought fractile,
a third processing module 1 processing the third datum of value P2 as reference datum, such as to produce an output datum V2 indicating whether or not P1 is the sought fractile.

The total number of primary comparators is at the most equal to 2n(n−1), e.g. 12 if n=3.

The filtering device 4 moreover comprises a module 6 for generating fractiles. The generating module 6 is connected to the respective outputs of the different processing modules 1 arranged in parallel, such that this generating module 6 receives n data Vi.

The generating module 6 is configured to select the value of one of the n input data as the output data on the basis of these data Vi.

In the embodiment illustrated in FIG. 4, the generating module 6 has a structure using only bitwise AND and OR operators. More precisely, the selecting module comprises a plurality of bitwise AND logic gates, each of these gates taking as input one of the Vi data, and moreover the associated datum Pi. The selecting module moreover comprises a bitwise OR type logic gate, taking as input the respective outputs of the bitwise AND logic gates. This gate supplies as output the fractile sought by the filtering device 4 (so for example the median value of the values of the n input data). This structure is advantageous since it does not contain any logic with priority. It therefore uses fewer logic levels than a structure containing such a priority logic, thus allowing a greater potential for increases in frequency.

In a variant, the generating module 6 may comprise a priority encoder of the fractile indicators, followed by a multiplexer.

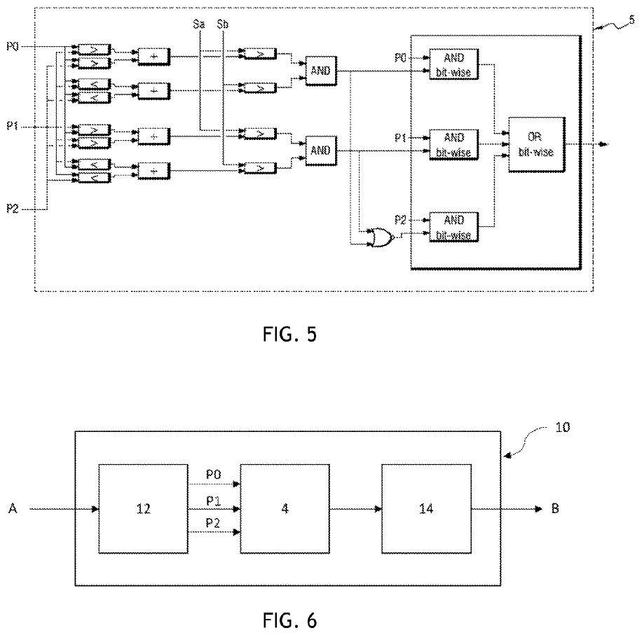

FIG. 5 shows a filtering device 5 according to a second embodiment. This filtering device 5 differs from the filtering device 4 by the fact that its number of processing modules 1 is strictly less than n, such that at least one of the n input data, the so-called remaining datum, is not processed as a reference datum by any one of the processing modules 1.

The filtering device 5 comprises a supplementary module 7 configured to generate an output datum indicating whether or not the remaining datum is the sought fractile, on the basis of the output datum generated by the processing modules 1.

The number of processing modules is for example equal to n−1, such that there is only one remaining input datum.

In the particular embodiment illustrated in FIG. 5, the number of processing modules 1 is equal to n−1, or 2 when n=3.

In fact, if all the other output data indicate negative results (i.e. the corresponding reference data are not the sought fractile), then, by elimination, the input datum for which no processing module has been associated (here, P2) is necessarily the sought fractile.

In practice, the supplementary module can be an additional logic gate of NOT OR (or NOR) type, taking as input the outputs of the processing modules Vi, and including the output at the fractile-generating module 6.

This embodiment is advantageous since the surface area required for the supplementary module is less than that of a processing module 1. The general surface area for implementing the device is thus reduced.

The filtering devices 4, 5 advantageously find an application in the image processing field. With reference to FIG. 6, an image-processing device 10 comprises a pixel-selecting module 12, at least one filtering device 4 arranged at the output of the pixel-selecting module 12, and an image-generating module 14 arranged at the output of the filtering device 4. Of course, the device 4 can be replaced by the device 5 in the image-processing device 10.

In general, the image-processing device 10 has the function of producing an output image filtered on the basis of an input image, this filtering being applied by the filtering device 4.

The pixel-selecting module 12 is configured to receive an input image A. The input image A comprises a plurality of pixels, each pixel having a position that is specific to it in the input image (this position typically having the form of a couple of row and column indices). Each pixel of the input image A moreover has a value that provides information on its color. In the following text, it will be assumed at first that each pixel of the input image A has a single value, which indicates a gray level.

The pixel-selecting module 12 is configured to select from the input image A a neighborhood of n pixels associated with a pixel of the image A, the so-called main pixel.

For example, in the case where n=3, this neighborhood typically comprises the main pixel, and two neighbor pixels of the main pixel. The two neighboring pixels are typically located on either side of the main pixel (on the same column or on the same row in the input image A)

In another embodiment wherein n=9, the neighborhood forms a square of pixels centered on the main pixel and comprising the eight neighboring pixels of the main pixel.

The filtering device 4 is arranged to receive as input the respective values of the neighborhood of n pixels selected by the pixel-selecting module 12. In other words, the input data processed by the filtering device 4 are here the n pixels that constitute the neighborhood of pixels selected by the pixel-selecting module 12.

The filtering device 4 supplies as input a filtered pixel value V, associated with the main pixel.

The image-processing device 10 is configured to repeat the preceding steps over several successive iterations, each iteration taking as input a new pixel of the input image considered as the main pixel by the pixel-selecting module 12.

After these successive iterations, the filtering device produces as filtered pixel values V as there are input pixels successively processed as main pixels by the pixel-selecting module.

The generating module 14 is configured to generate an output image B on the basis of all these filtered pixel values V supplied by the filtering device 4.

In a particularly advantageous embodiment of the image-processing device 10, n is odd and Sa=Sb=(n+1)/2 (in which case the filtering device 4 acts as a median filter). Specifically, this embodiment makes it possible to eliminate the erroneous pixel values from the input image A.

In the above text, the assumption has been made that the image-processing device 10 is processing an input image in gray levels. In a variant, the image-processing device 10 can be configured to process color input images. In this case, each pixel of the input image can comprise not one single value but a k-uplet of color components, the k-uplet being a characteristic of the color of the pixel. This k-uplet is for example a triplet of red, green and blue components. In other words, the input image is a superimposition of k elementary images, each elementary image relating to one of the k components of the input image A.

The pixel-selecting module 12 is configured to supply to the filtering device the n pixel values of a neighborhood belonging to the same color component. The filtering device can thus be used k times, once per component, thus allowing the generating module to generate a color output image.

In a variant, the image-processing device 10 may comprise k filtering devices 4 arranged in parallel, each filtering device 4 being associated with one of the k components of the input image.

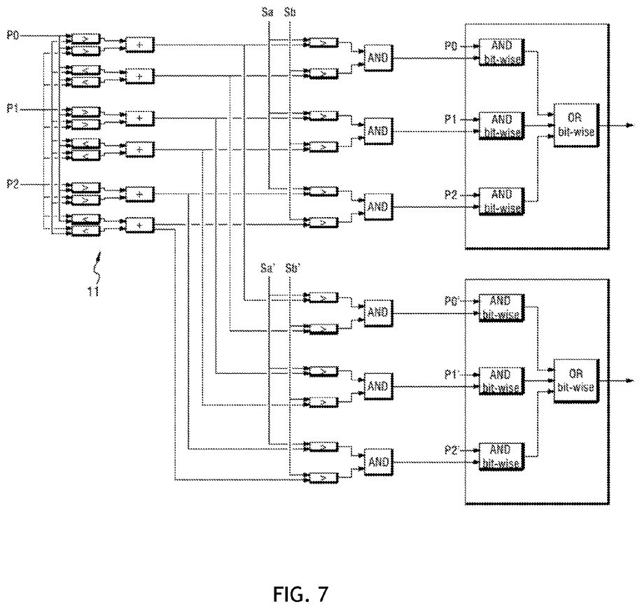

FIG. 7 shows a third embodiment of the filtering device 11.

The filtering device 11 comprises all the components of the filtering device 4, in particular the three processing modules 1 previously discussed, with the aim of testing whether or not different input data are a predetermined fractile of the set, which will subsequently be referred to as the first fractile, with the help of the thresholds Sa and Sb.

The filtering device 11 moreover comprises three supplementary processing modules having the same structure as the modules of the device 4, but testing a second fractile different from the first fractile, using thresholds Sa′ and Sb′ having potentially different values from the thresholds Sa and Sb.

These three supplementary processing modules are:
a fourth processing module 1 processing the first data of value P0 as the reference datum, such as to produce the output datum V′0 which indicates whether or not P0 is the second sought fractile
a fifth processing module 1 processing the second data of value P1 as the reference datum, such as to produce an output datum V′1 indicating whether or not P1 is the second sought fractile,
a sixth processing module 1 processing the third data of value P2 as the reference datum, such as to produce an output datum V′2 indicating whether or not P1 is the second sought fractile.

The filtering device 11 comprises the same n inputs as the filtering device 4. On the other hand, it comprises two outputs and not just one; the first output, already present in the filtering device 4, delivers the first fractile, and the second output delivers the second fractile. This second output is delivered by a supplementary fractile-generating module having for example an identical structure to the module 6 shown in FIG. 4.

Several processing modules use the same primary comparators and the same adders:
the first processing module and the fourth processing module,
the second processing module and the fifth processing module,
the third processing module and the sixth processing module

It will be observed that several components have here been mutualized to obtain several different fractiles. This principle can of course be generalized to more than two fractiles.

It can also be considered that, in this embodiment, a processing module 1 is “extended” to implement the following additional steps:
b′) compare the sum computed in step a) with a third threshold (Sa′),
d′) compare the sum computed in step c) with a fourth threshold (Sb′),
e′) generate an output datum indicating whether or not the reference datum is a different second predetermined fractile or fractiles from the fractile determined in step e), only if both the following conditions are satisfied: the sum computed in step a) is less, strictly or not, than the third threshold (Sa′) and the sum computed in step c) is less than, strictly or not, than the fourth threshold (Sb′).

For the two fractiles tested by this “extended” module to be different, the pair of thresholds (Sa′, Sb′) is different from the pair of thresholds (Sa, Sb).

Optimization by Symmetry

In the filtering device 4 shown in FIG. 4, the total number of primary comparators needed to obtain the n data Vi which are then passed as input to the output selecting module is relatively large.

To reduce this number, and consequently the total surface area of the filtering device 4, it is possible to arrange it so that a primary comparator is not only used to produce an output datum Vi associated with an input datum Pi, but also to produce an output datum Vj associated with a different input datum Pj.

This optimization is referred to as an optimization by symmetry as it is based on the symmetrical nature of the comparisons made: “x strictly greater than y” is equivalent to “y strictly less than x”.

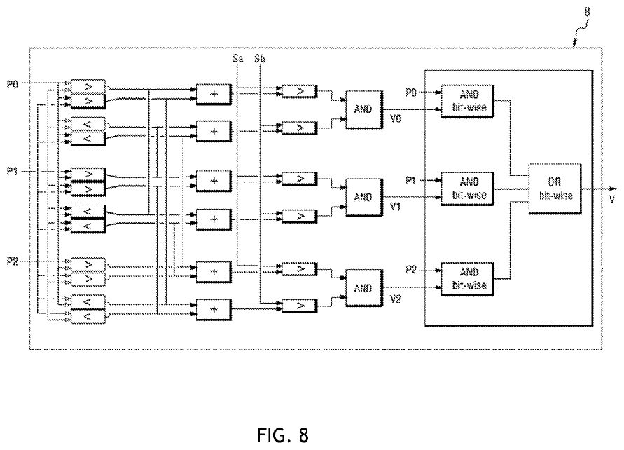

FIG. 8 shows a filtering device 8 optimized by symmetry, wherein n=3. This filtering device 8 comprises components of the same type as those of the filtering device 4, but differs therefrom by a smaller number of primary comparators.

Take the case of the first processing module associated with the first input datum of value P0 and producing the datum V0, and the second processing module associated with the second input datum of value P1.

A primary comparator configured to compare the respective values P0, P1 of the first input datum and of the second input datum is part of the first group of comparators of the first processing module, and is at the same time part of the second group of comparators of the second processing module. In other words, this comparator is configured to compare P0 and P1 and to supply a result which is then used by two adders:
the adder of the first processing module which is configured to implement the step a), and
the adder of the second processing module configured to implement the step c).

There is moreover another primary comparator configured to compare the respective values P0, P1 of the first input datum and of the second input datum, forming part of the second group of comparators of the processing module, and is at the same time part of the first group of comparators of the second processing module. In other words, this comparator is configured to compare P0 and P1 and to supply a result which is then used by two adders:
the adder of the first processing module which is configured to implement step c), and
the adder of the second processing module configured to implement step a).

Finally, the first processing module and the second processing module have both the preceding comparators in common, and these two comparators in common have the particularity of comparing the respective values of both the data associated with these two processing modules.

This principle may be generalized to each pair of processing modules present in the filtering device. It is thus possible to divide by two the total number of primary comparators, which makes it possible to further reduce the implementation surface area of the filtering device.

In the embodiment illustrated in FIG. 8, wherein n=3, the modules removed by this optimization by symmetry appear grayed out. The total number of primary comparators is reduced to 6 (instead of 12 in the embodiment illustrated in FIG. 4).

It will be understood that the same type of optimization by symmetry can be made in filtering devices comprising processing modules 2 compliant with the second embodiment, or processing modules 3 compliant with the third embodiment.

It will be understood that the filtering device 8 optimized by symmetry can replace the filtering device 4 in the image-processing device 10.

Optimization by Sliding Sum

The progress of steps a) and c) implemented by any of the processing modules 1, 2, 3 can also be optimized when the processing module in question is made to function repeatedly by successive iterations on mutually overlapping sets of input data.

This type of optimization, which is known as optimization by sliding sum, is in particular possible when the processing module according to one of these embodiments is part of a filtering device which is itself part of an image-processing device 10 such as that shown in FIG. 6. Specifically, the pixel-selecting module 12 can be configured to operate a scan of the input image A, such that the neighborhood of n pixels selected during a current iteration and the neighborhood of n pixels selected during a preceding iteration overlap. The two neighborhoods are for example horizontally or vertically offset by one pixel (which means that the two pixels successively processed as the reference pixel by the pixel selection module 12 during these two successive iterations are mutual neighbors).

By convention, the term “current set” refers to a set of n input data processed by a processing module of the filtering device during a current iteration, and “preceding set” a set of n input data processed by the same processing module during a preceding iteration.

The current set differs from the preceding set in that it comprises at least one new input datum which was not present in the preceding set, and in that it does not comprise at least one old datum which was however present in the preceding set. The current set does nonetheless have at least one input datum in common with the preceding set.

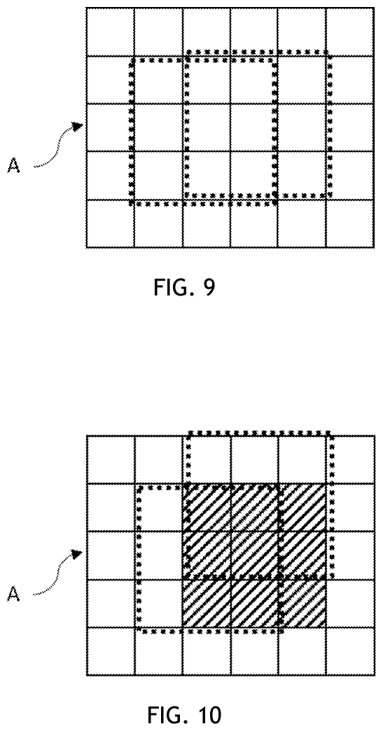

FIG. 9 shows a part of the input image A, and two pixel neighborhoods (in dotted lines) selected by the pixel-selecting module 12 during two successive iterations, in an embodiment wherein n=9. In this embodiment, there are three new input data, six data in common, and three old data.

In the following text, it is supposed that the current iteration and the preceding iteration are processing the same input datum as the reference datum. It is in this case possible to optimize the internal operation of the processing module implementing these two iterations. The example of the processing module according to the first embodiment shown in FIG. 1 will be used, but the following is also applicable to the embodiments of FIGS. 2 and 3.

As a reminder, in step a) there is a calculation of the number of input data other than the reference datum which have values strictly less than the value of the reference datum, and during step c) the number of input data other than the reference datum which have values strictly greater than the value of the reference datum. In the embodiments shown in FIGS. 1, 2 and 3, these steps a) and c) comprise the initialization of a first counter and of a second counter to zero.

To optimize the implementation of step a) during the current iteration, the sum computed during the step a) of the preceding iteration is advantageously saved. The step a) of the current iteration then comprises the following steps:
a1) initializing the first counter to said saved sum,
a2) for each new datum of the current set, incrementing the first counter by one only if the value of the new datum is strictly less than the value of the reference datum,
a3) for each old datum, decrementing the first counter by one only if the value of the old datum is strictly less than the value of the reference datum.

Similarly, to optimize the implementation of step c) during the current iteration, the sum computed during step c) of the preceding iteration is advantageously saved. The step c) of the current iteration then comprises the following steps:
c1) initializing the second to said saved sum,
c2) for each new datum of the current set, incrementing the second counter by one only if the value of the new datum is strictly greater than the value of the reference datum.
c3) for each old datum, decrementing the second counter by one only if the value of the old datum is strictly greater than the value of the reference datum.

In the embodiment shown above, the steps a2), a3), c2) and c3) use relationships of strict order. However, this is not necessary to implement an optimization by sliding sum.

In another embodiment, the input data processed by one and the same processing module 1, 2, 3 as the reference datum during the current iteration and during the preceding iteration are different. In this case, the optimization by sliding sum implies a communication between different processing modules of the filtering device. Specifically, steps a1-a3) or c1-3) implemented by a processing module are then based on a sum saved by another processing module.

These optimizations by sliding sum are advantageous since they make it possible to reduce the number of comparisons and additions implemented by the processing module during steps a) and c) of the current iteration.

To implement such optimizations, ternary adders can be used which have three inputs instead of two as illustrated in FIGS. 1 to 3 (the third input being used to receive the value saved in the preceding iteration). Such adders may be implemented using a bitwise LUT6.

Optimization by Propagation

It is also possible, in the event of overlap between two sets of data processed in sequence, to limit the total number of comparisons made by the primary comparators of the filtering device 4 or 8, or even of the processing module 1, 2 or 3.

This optimization, so-called “optimization by propagation”, is based on the idea that two input data in common between a current set and a preceding set do not need to be compared twice, once during the preceding iteration and once again during the current iteration. Instead of this, the result of a comparison between two values made during the preceding iteration is saved, then re-used by an adder during the current iteration, if it proves that these two values pertain to input data that are still present in the set processed during the current iteration.

For example, suppose that one of the processing modules shown in FIG. 1, 2 or 3, wherein n=3, has processed three input data having the values P0, P1, P2 during a preceding iteration, and the filtering device must process during a current iteration a set of input data having a new input datum of value P3, but not comprising the input datum of value P0 (which is therefore an old value). In other words, P0 becomes P1, P1 becomes P2, and P2 becomes P3.

In this case, during the preceding iteration the result of a comparison made between the values P1 and P2 can be saved; this saved result can then be used by an adder during the current iteration.

It should be noted that this optimization by propagation is not limited to the case of an iteration immediately preceding the current iteration, but can be generalized to several prior iterations, more or less old. This is because one may find in older iterations comparisons already made, and which can be reused for the current iteration.

FIG. 10 shows a part of the input image A, in an embodiment wherein n=9, two neighborhoods of pixels (in thin dotted lines) selected by the pixel-selecting module 12 during two separate prior iterations, so-called preceding sets, and a neighborhood of pixels (the pixels of which are hatched) selected by the pixel-selecting module 12 during a current iteration, the so-called current set. In this embodiment, there is a new datum, four partially common data, four completely common data and six old data. The term “partially common datum” should be understood to mean data of the current set which belong to only one of the preceding sets, and the term “completely common data” data of the current set which belong to the two preceding sets.

During preceding iterations, the filtering device 4, 8 has already produced the results of the comparisons between the values of the completely common data, the results of the comparisons between the values of the partially common data and the values of the completely common data and the results of the comparisons between the values of partially common data which belong to the same preceding set. According to the optimization by propagation these results have been saved.

Contrarywise, the comparisons between the values of the partially common sets of data, which come from one and the other of the two preceding sets respectively, have not been made by the filtering device 4, 8 during a preceding iteration (4 comparisons if n=9). In the same way, no comparison has been made between the value of the new datum and those of the other data of the current set (8 if n=9).

If n=9, the filtering device must therefore perform 12 comparisons during the current step with optimization by propagation versus 72 (9 times 8) comparisons without optimization by propagation.

This optimization by propagation therefore offers the advantage of greatly reducing the number of comparisons to be made during a current iteration, the filtering device 4, 8 being limited to making comparisons, the results of which have not been previously produced.

Other Variant Embodiments of Tests on a Fractile

In the previously described embodiments, the conditions verified in step e) are based on a relationship of strict order (<): thus, it is verified whether or not the number obtained in step a) is strictly less than the first threshold Sa, and similarly whether or not the number obtained in step c) is strictly less than the threshold Sb. Moreover, the sum of the thresholds Sa and Sb has a value of n+1.

In a variant, provision may be made for at least one of the two conditions verified in step e) to be based on a relationship of non-strict order W. In this case, the sum of the thresholds Sa and Sb may be equal to n−1 (insofar as the two conditions use the order relationship or else equal to n (insofar as one of the two conditions uses the order relationship and the other uses the relationship of strict order <). This variant makes it possible to obtain the same output datum Vi as that previously discussed.

It is also possible to choose the thresholds Sa and Sb to have non-integer values.

In summary, one generally has the following: the sum of the two thresholds is equal to n+p, with p∈[−1, 1], p being a function of knowing whether or not the sum computed in step a) must be strictly less than the first threshold and whether or not the sum computed in step b) must be strictly less than the second threshold, for the two conditions to be satisfied. In other words, p is a function of the strict or non-strict nature of the order relationships used during step e).

The tested fractile is not necessarily the median. The fractile f tested by a processing module may be any (f being a percentage, included between 0% and 100%). One can then adjust the thresholds as follows: Sa=lower round-off (f*n)+1 and Sb=(n+1)−Sa (or conversely, by first computing Sb=upper round-off ((1−f)*n) and Sa=(n+1)−Sb). The term upper round-off should be understood to mean lower round-off+1.

Generalization to a Test of Belonging to a Subset of Several Fractiles

The processing modules 1, 2, 3 previously discussed have the function of testing whether or not a reference input datum is a specific fractile, for example the median of the set of n input data.

This test may be generalized: it can thus be tested by a processing module if the reference datum is a fractile of the set of n data which is included in a predetermined subset of fractiles. The term “subset” of fractiles means that there is at least one fractile not belonging to this subset. In other word, the sought subset of fractiles is not the set of all possible fractiles, ranging from 0% to 100%, but is included therein.

Preferably, at least one out of the minimum and the maximum of the set of n data is excluded from the predetermined subset of fractiles. In other word, the test applied by a processing module to a reference datum having a maximum or minimum value in the set of n data will be negative.

To obtain such a generalization, the thresholds Sa, Sb used in the modules 1, 2 or 3 may be set to values such that their sum is not necessarily equal to n+p. These thresholds define a continuous subset of several fractiles. It can also be envisioned to replicate the device as shown in FIG. 7 to obtain a discontinuous subset of several fractiles.

In a particular variant, the subset of several fractiles is continuous, comprises the median of the set of n data, and comprises at least one other fractile.

Other Variant Embodiments of the Generating Module

In the illustrated embodiments, the generating module 6 operates as a selector. Provision can however be made for other embodiments in which the value produced at the output of this module does not correspond to any of the respective values of the n input data. This case can notably occur when n is even. In this case, there may be two medians (a low median and a high median). The generating module 6 can then compute the arithmetic mean of these two medians.

Generalization to Sets of Weighted Input Data

In the previously described embodiments, a count is made of input data during the steps a) and c) (the increment used to increment the first counter and the second counter has a value of one).

The n input data processed by any of the embodiments described above may however be weighted. In this case, each input datum is associated with a predetermined weight, which is in addition to the value of the input datum. The modifications are then made to a processing module.

In step a), a computation is made of the sum of the weights associated only with input data other than the reference datum which have values strictly less than the value of the reference datum. Similarly, in step c), a computation is made of the sum of the weights associated only with input data other than the reference datum which have values strictly greater than the value of the reference datum. In other words, the first counter and the second counter are incremented with weights, and no longer necessarily with one.

Moreover, the sum of the first threshold Sa and the second threshold Sb is chosen equal to s+p, s being the sum of the weights of the n input data.

The embodiments previously set out in relation to the figures therefore constitute a special case of this general principle, wherein the respective weights of the n input data are all equal to one.

Note for example the following particular exemplary embodiments:

| | | Order relationship | Determined quartile of |
|---|---|---|---|
| Value of Sa | Value of Sb | used in step e) | the set of n input data |
| s | 1 | < | Minimum |
| (s + 1 )/2 | (s + 1)/2 | < | Median (if n odd) |
| 1 | s | < | Maximum |
| s − 1 | 0 | ≤ | Minimum |
| (s − 1)/2 | (s − 1)/2 | ≤ | Median (if n odd) |
| 1 | s | ≤ | Maximum |

Moreover, in the abovementioned application wherein a processing module takes as input n pixels forming a pixel neighborhood in the image pertaining to a reference pixel, the weight associated with a pixel of the neighborhood can be a function of the relative position between this pixel and the reference pixel. By way of non-limiting example, one may choose to assign the reference pixel a high weight, by comparison with the pixels assigned to the pixels surrounding it.

All the embodiments illustrated in the figures, for which n=3 or n=9, can be generalized to any number n greater than 3. The number n is however preferably odd, which advantageously lends itself to the implementation of a pixel filter centered on a reference pixel, this filter taking into account the reference pixel. Very preferably, n is an odd square (which allows the implementation of a filter on a pixel neighborhood of square shape around a reference pixel, this filter taking into account the reference pixel). Note in particular the cases n=3, n=9, n=25 as examples of odd squares, which can be applicable to all the embodiments previously described.

It has been observed that each of the processing modules 1, 2, 3 respectively shown in FIGS. 1, 2 and 3 are suitable for implementing the method for processing a set of n input data disclosed at the start of this detailed description, comprising the steps a) to d). These different processing modules 1, 2, 3 typically take the form of electronic circuits (FPGA, ASIC or others); the different units shown in these figures are thus physical components included in these electronic circuits. At different levels, these processing modules occupy a very limited surface area as they do not do any complex operations such as a sort.

The above is also valid for the filtering devices and image-processing devices previously discussed.

It may however be envisioned that the same method for processing n input data is implemented in software, by a non-specialist computer. The steps of the method are thus encoded in the form of a computer program implemented by one or more processors. The same more generally applies for the filtering method implemented by one of the filtering devices illustrated in FIGS. 4 and 5, or even for the image processing method implemented by the image-processing device 10 shown in FIG. 6.

In the embodiments described in the figures, processing modules 1, 2, 3 are used in parallel, which reduces the average time of determination of a sought fractile. In a variant, it can be envisioned to sequentially repeat the processing method implemented by a processing module 1, 2 or 3, rather than performing it in parallel, until a fractile is found which matches that which is sought. This repetition is particularly easy to implement when the method is implemented in software; it is in this case possible to use only a single processor for this sequential implementation. This variant is on average slower than the parallel variant, but has the advantage of consuming less computing load at a time t.

A sequential implementation is furthermore particularly advantageous when one is searching not a single fractile, but more generally a fractile belonging to a continuous subset of fractiles. This is because the execution of the method will still be fast, since a test of belonging to a subset is easier to verify than a single fractile search. One may for example be content with a fractile close to the median, insofar as the time taken to obtain it is faster than the time that would need to be devoted to the accurate determination of the median.

1. A module for processing a set of n input data comprising a reference datum, each input datum having a value, each input datum being associated with a weight, the processing module being configured to:
a) compute a first sum of weights associated solely with input data other than the reference datum which have values strictly less than the value of the reference datum,
b) compare the first sum with a first threshold,
c) compute a second sum of weights associated solely with input data other than the reference datum which have values strictly greater than the value of the reference datum,
d) compare the second sum with a second threshold,
e) generate an output datum indicating whether or not the reference datum is a fractile of the set included in a predetermined subset of fractiles, only if both following conditions are satisfied: the first sum is less, strictly or not, than the first threshold and the second sum is less, strictly or not, than the second threshold.

2. The processing module as claimed in claim 1, comprising:
a plurality of first comparators arranged in parallel, each first comparator being configured to generate a result of a comparison between the value of the reference datum and the value of another input datum of the set,
a first adder configured to compute the first sum on the basis of the results generated by the first comparators.

3. The processing module as claimed in claim 1, comprising:
a plurality of second comparators arranged in parallel, each second comparator being configured to generate a result of a comparison between the value of the reference datum and the value of another input datum of the set,
a second adder configured to compute the first sum on the basis of the results generated by the second comparators.

4. The processing module as claimed in claim 1, comprising two comparators configured to respectively generate two results of a comparison between the value of the reference datum and the value of another input datum of the set, wherein one of the two comparators is configured to merely testing an equality between the value of the reference datum and the value of the other input datum of the set, and the other of the two comparators is configured to merely testing an order relationship between the value of the reference datum and the value of the other input datum of the set, the processing module being further configured to cross the two results to determine if the weight of the other value is to be included in the first sum or in the second sum.

5. The processing module as claimed in claim 1, wherein a sum of the first threshold and the second threshold is equal to s+p, where s is the sum of the weights of the n input data, and where p∈[−1, 1], p depending of whether or not the first sum must be strictly less than the first threshold and whether or not the second sum must be strictly less than the second threshold for the conditions to be satisfied.

6. The processing module as claimed in claim 1, wherein the predetermined set of fractiles consists of a single fractile.

7. The processing module as claimed in claim 1, wherein the predetermined set of fractiles comprises a median of the set of n input data.

8. The processing module as claimed in claim 1, wherein the n weights are all equal to 1.

9. The processing module as claimed in claim 1, wherein the set of n input data is a neighborhood of pixels in an image.

10. The processing module as claimed in claim 1, wherein compute the first sum comprises:
a1) initializing a first counter to a sum that has been computed during a preceding implementation of step a) during which the processing module during processed a preceding set of data comprising the reference datum, the set of n input data further comprising at least one new datum which was not present in the preceding set of data, and the preceding set of data comprises at least one old datum which is not present in the set of n input data,
a2) for each new datum, incrementing the first counter with the weight associated with the new datum, only if a predetermined relationship between the value of the new datum and the value of the reference datum is verified,
a3) for each old datum, decrementing the first counter with the weight associated with the old datum, only if a predetermined relationship between the value of the old datum and the value of the reference datum is verified.

11. The processing module as claimed in claim 1, wherein compute the second sum comprises:
c1) initializing a second counter to a sum that has been computed during a preceding implementation of step c) during which the by the processing module processed a preceding set of data comprising the same reference datum, the set of n input data moreover comprising at least one new datum which was not present in the preceding set of data, and the preceding set of data comprises at least one old datum which is not present in the set of n input data,
c2) for each new datum, incrementing the second counter with the weight associated with the new datum, only if a predetermined relationship between the value of the new datum and the value of the reference datum is verified,
c3) for each old datum, decrementing the second counter with the weight associated with the old datum, only if a predetermined relationship between the value of the old datum and the value of the reference datum is verified.

12. (canceled)

13. (canceled)

14. The processing module as claimed in claim 1, further configured to:
b′) compare the first sum and a third threshold,
d′) compare the second sum and a fourth threshold,
e′) generate an output datum indicating whether or not the reference datum is a fractile of the set included in a second predetermined subset of fractiles different from the subset of step e), only if the both following conditions are satisfied: the first sum is less, strictly or not, than the third threshold and the second sum is less, strictly or not, than the fourth threshold.

15. A device for filtering a set of n input data such as to produce a fractile of the set included in a predetermined subset of fractiles, each input datum having a value, each input datum being associated with a weight, the filtering device comprising:
a plurality of processing modules as claimed in claim 1 arranged in parallel, each processing module being itself associated with one of the n input data and configured to process as reference datum the input datum of the set with which it is itself associated,
a fractile-generating module configured to generate the fractile on the basis of the output data respectively generated by the processing modules.

16. The filtering device as claimed in claim 15, wherein the fractile-generating module is configured to:
f) for each output datum generated by any of the processing modules, apply a bitwise AND operation to the output datum and to the value of the input datum associated with the processing module itself, such as to produce results,
g) apply an bitwise OR operation to the results produced at step f).

17. The filtering device as claimed in claim 15, comprising a comparator configured to generate a result of a comparison between the value of a first datum of the set and the value of a second datum of the set, and wherein the plurality of processing modules comprises:
a first processing module configured to process as reference datum a first datum of the set, the first processing module being configured to compute the first sum or the second sum on the basis of the result generated by the comparator,
a second processing module configured to process as reference datum a second datum of the set, the second processing module being configured compute the first sum or the second sum on the basis of the result generated by the comparator.

18. The filtering device as claimed in claim 15, wherein the set of n input data comprises two input data in common with a preceding set of data previously processed by the filtering device, and wherein one of the processing modules is configured to compute the first sum or the second sum on the basis of a result of a comparison between the two common input data that has been previously generated by the processing module to process the preceding set of data.

19. The filtering device as claimed in claim 15, wherein step a) implemented by one of the processing modules comprises:
a1) initializing a first counter to a sum that has been computed during a preceding implementation of step a) to filter a preceding set of data, the set of n input data comprising at least one new datum which was not present in the preceding set of data, and comprising an input datum in common with the preceding set of data, the preceding set of data comprising at least one old datum which is not present in the set of n input data,
a2) for each new datum, incrementing the first counter with the weight associated with the new datum, only if a predetermined relationship between the value of the new datum and the value of the common input datum is verified,
a3) for each old datum, decrementing the first counter with the weight associated with the old datum, only if a predetermined relationship between the value of the old datum and the value of the common input datum is verified.

20. The filtering device as claimed in claim 15, wherein step c) implemented by one of the processing modules comprises:
c1) initializing a second counter to a sum that has been computed during a preceding implementation of step c) to filter a preceding set of data, the set of n input data comprising at least one new datum which was not present in the preceding set of data, and comprising an input datum in common with the preceding set of data, the preceding set of data comprising at least one old datum which is not present in the set of n input data,
c2) for each new datum, incrementing the second counter with the weight associated with the new datum, only if a predetermined relationship between the value of the new datum and the value of the common input datum is verified,
c3) for each old datum, decrementing the second counter with the weight associated with the old datum, only if a predetermined relationship between the value of the old datum and the value of the common input datum is verified.

21. (canceled)

22. The filtering device as claimed in claim 15, wherein the number of processing modules arranged in parallel is strictly less than n, such that at least one of the n input data, so-called remaining datum, is not processed as a reference datum by any of the processing modules, the filtering device further comprising an additional module configured to generate an output datum indicating whether or not the remaining datum is a fractile of the set included in the predetermined sub-set of fractiles, on the basis of the output data generated by the processing modules.

23. An image-processing device comprising:
a pixel selecting module configured to select a neighborhood of n pixels in an input image,
a filtering device as claimed in claim 15 configured to filter the selected neighborhood of n pixels, such as to produce a fractile of the neighborhood of n pixels, the fractile constituting a value of a pixel of an output image produced by the image-processing device from the input image.

24. A method of processing a set of n input data comprising a reference datum, each input datum having a value, each input datum being associated with a weight, the method comprising the following steps implemented by a processing module:
a) computing a first sum of weights associated solely with input data other than the reference datum which have values strictly less than the value of the reference datum,
b) comparing the first sum with a first threshold,
c) computing a second sum of weights associated solely with input data other than the reference datum which have values strictly greater than the value of the reference datum,
d) comparing the second sum with a second threshold,
e) generating an output datum indicating whether or not the reference datum is a fractile of the set included in a predetermined subset of fractiles, only if both following conditions are satisfied: the first sum is less, strictly or not, than the first threshold and the second sum is less, strictly or not, than the second threshold.

25. A method of filtering a set of n input data such as to produce a fractile of the set included in a predetermined subset of fractiles, each input datum having a value, each input datum being moreover associated with a weight, the method comprising:
implementing a processing method according to claim 24 several times in parallel, each implementation of said processing method processing a different input datum from the set as the reference datum,
generating the fractile on the basis of the output data generated during parallel implementations of the processing method.

26. (canceled)

27. A non-transitory computer-readable medium comprising code instructions for causing a computer to perform the method as claimed in claim 24 or claim 25.
